(19) United States
(12) Patent Application Publication
(10) Pub. No.: US 2016/0225030 A1
(43) Pub. Date: Aug. 4, 2016

(54) SOCIAL DATA COLLECTION AND AUTOMATED SOCIAL REPLIES

(71) Applicant: Adobe Systems Incorporated, San Jose, CA (US)

(72) Inventors: KANNAN IYER, SAN RAMON, CA (US); CHAD MICHAEL KRSEK, SAN FRANCISCO, CA (US); WALTER W. CHANG, SAN JOSE, CA (US); SACHIN SONI, NEW DELHI (IN); ASHISH DUGGAL, DELHI (IN); ANMOL DHAWAN, GHAZIABAD (IN)

(21) Appl. No.: 14/611,830

(22) Filed: Feb. 2, 2015

(51) Int. Cl. G06Q 30/02; G06F 17/27; G06Q 50/00; G06F 17/30

(52) U.S. Cl. CPC G06Q 30/0269; G06F 17/30563; G06F 17/2705; G06F 17/3053; G06Q 30/0277; G06Q 50/01

(57) ABSTRACT

A social analysis tool facilitates improved communications between marketers and consumers. User information for consumers is collected from social posts exchanged between consumers and moderators acting on behalf of marketers. The user information is stored in social profiles for the consumers and is available to the marketers for subsequent social conversations with the consumers. In some instances, consumers are effectively targeted for automated social replies that market a newer version of a product. Social posts relevant to the product are analyzed to identify ones in which the user sentiment indicates the user is satisfied with the product. Automated social replies are automatically generated and sent in response to each of those social posts.

### BACKGROUND

Social networking has become an increasingly popular presence on the Internet. Social networking services allow users to easily connect with friends, family members, and other users in order to share, among other things, comments regarding activities, interests, and other thoughts. As social networking has continued to grow, marketers have recognized value in the technology. For instance, marketers have found that social networking provides a great tool for managing their brand and driving consumers to their own web sites or to otherwise purchase their products or services.

To assist marketers in their social networking efforts, some social analysis tools, such as the ADOBE SOCIAL tool, have been developed that provide mechanisms for marketers to collect information regarding what consumers are saying and manage responses to consumers' social networking messages. Using such social analysis tools, marketers can conduct social conversations with consumers by exchanging social posts with the consumers. However, the marketers often don't have sufficient information regarding consumers to adequately serve them. Marketers may also use social analysis tools to target consumers with social posts promoting new versions of their products. While this presents a powerful way to reach consumers to promote the new versions of products, it has proven difficult to effectively identify which consumers to target, when to target each consumer, and what message to send to each consumer.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Embodiments of the present invention generally relate to more effectively communicating with consumers. More particularly, some embodiments are directed to automating identifying and extracting user information from social conversations between a user and a moderator managing a marketer's social networking presence and storing the user information in a user profile. As such, the user information is available to the marketer to facilitate future communications with the consumer. User information is identified by automatically analyzing social posts from a moderated social conversation between a moderator and user. The user information is extracted and mapped to social profile data fields corresponding with different types of user information. The user information is then stored in the social profile.

Further embodiments are directed to effectively targeting users with social messages that promote a newer version of a product. Users to target with the messages are automatically identified by first identifying social posts relevant to the product. The social posts are analyzed to identify ones in which the user sentiment associated with the product satisfies a sentiment threshold reflecting that the users are satisfied with the product. Automated social replies are then generated and sent only in response to the social posts in which the user sentiment satisfies the sentiment threshold. As such, the messages are more effectively targeted to users who are satisfied with the product and therefore more like to respond positively to the automated social replies. In some embodiments, an automated social reply to a particular social post may be customized to emphasize new or improved features of the newer version of the product that are of interest to the user as reflected by the user discussing those features in the social post.

### BRIEF DESCRIPTION OF THE DRAWINGS

The present invention is described in detail below with reference to the attached drawing figures, wherein:

FIG. 1 is a block diagram showing a system for identifying user information in social posts of a moderated social conversation, extracting the user information, and storing the user information in a social profile in accordance with an embodiment of the present invention;

FIG. 2 is a flow diagram showing a method for identifying user information in social posts of a moderated social conversation, extracting the user information, and storing the user information in a social profile in accordance with an embodiment of the present invention;

FIG. 3 is a flow diagram for identifying user information in the text of social posts from a moderated social conversation in accordance with embodiments of the present invention;

FIG. 4 is a screenshot of an exemplary moderator user interface showing user information being emphasized in moderated social conversations;

FIG. 5 is a diagram illustrating an exemplary data structure for storing social profiles in accordance with an embodiment of the present invention;

FIG. 6 is a diagram illustrating an exemplary data structure for storing user information in association with moderated social conversations;

FIG. 7 is a block diagram showing a system for providing automated social replies in response to social posts based on user sentiment associated with products discussed in the social posts in accordance with an embodiment of the present invention;

FIG. 8 is a flow diagram showing a method for generating and providing an automated social reply based on the user sentiment associated with a product discussed in a social post in accordance with an embodiment of the present invention;

FIG. 9 is a flow diagram showing a method for generating an automated social reply in accordance with an embodiment of the present invention; and

FIG. 10 is a block diagram of an exemplary computing environment suitable for use in implementing embodiments of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various terms are used throughout this description. Definitions of some terms are included below to provide a clearer understanding of the ideas disclosed herein:

The terms “social networking service” and “social networking site” refer to any computerized online presence at which a user may share messages with other users within a social network. For instance, this may include services, such as the TWITTER, FACEBOOK, LINKEDIN, TUMBLR, QUORA, and YOUTUBE services, to name a few.

A “social post” includes any message posted by a user via a social networking service. A social post may include both the content of the user's message (e.g., text, images, video, audio, etc.) and metadata associated with the message. A social post may be a public communication that may be viewed by other members of a social networking service on which it was posted, or a social post may be a private communication, such as a TWITTER direct message or a FACEBOOK private message.

A “social analysis tool” refers to software that facilitates a marketer's analysis of social networks. Among other things, a social analysis tool may be used by a marketer to collect information from social networking services and to manage social content and messages using social networking services.

A “moderator” is a person who is responsible for employing a social analysis tool on behalf of a marketer to, among other things, review social posts and interact with users via social networking services.

A “marketer” refers to an entity that markets one or more products or services. For instance, a marketer may be a company that manufactures, distributes, and/or sells a product or offers a service or an entity that markets such a company's product or service on behalf of the company.

A “moderated social conversation” is an exchange of social posts between a user and a moderator.

A “social profile” comprises a collection of user information for a user who has a presence on one or more social networking services.

A “version” refers to a release or series of a product that differs from other releases or series.

An “automated social reply” is a messaged provided to a user who submitted a social post within the confines of the social networking service on which the social post was submitted, such as, for example, a reply to the social post, a general post within the user's social networking account, or a promoted post within the user's social networking account (e.g., a promoted post delivered via the user's FACEBOOK account, or a promoted tweet delivered via a user's TWITTER account).

Marketers put in a lot of time and effort in interacting with users through social networking services. For instance, a moderator who is responsible for managing a marketer's social networking activities may interact with a consumer on behalf of the marketer via moderated social conversations that include an exchange of social posts over a social networking service between the moderator and the consumer. A marketer may engage with a consumer through a moderated social conversation for a variety of reasons. For example, a moderated social conversation may be conducted to resolve a particular issue the consumer is facing with the marketer's product, provide product information to the consumer, or otherwise engage with the consumer to promote brand awareness. Often, to better serve the consumer, the moderator may need to collect user information from the consumer, such as the version of the product the consumer owns, product features important to the consumer, other ways to contact the consumer (e.g., email address, identity on other social networks), etc. Collecting such information may be a tedious process. In some instances, a moderator may rely on customer information from a service, such as the FLIPTOP service. However, such information is typically limited to only publicly available information and is therefore insufficient for the moderator's purposes.

When marketers release new versions of products, the marketers wish to reach out to customers via social networking services to entice the customers to buy the new versions of the products. For instance, a smartphone manufacturer may wish to reach out to consumers each time a new version of its smartphone is released. One approach may be to send social posts to all existing customers who have a previous version of the product. However, the number of existing customers and corresponding volume of social posts may be very high and only increase as social media participation continues to grow. Additionally, reaching out to existing customers with a generic message regarding the new version of the product may not be an effective way to get the existing customers to purchase the new version of the product. Moreover, just reaching out to existing customers misses the opportunity to market the new version of the product to new potential customers. However, identifying which new potential customers to target is difficult.

Some embodiments of the present invention are directed to collecting user information provided by a consumer during a moderated social conversation between the consumer and a moderator and storing the user information in a social profile for the user. Because a moderated social conversation may be a private conversation between the consumer and the moderator, the consumer may be more willing to share private information that is not otherwise available. User information is identified from a moderated social conversation by analyzing text of the social posts from the conversation using known patterns and keywords associated with different types of user information. Identified user information is identified and mapped to data fields of a social profile corresponding with different types of user information. Data fields of the social profile are then populated with the social information.

User information stored in a social profile for a consumer may be used for subsequent communications with the consumer. For instance, if the consumer provided an email address and expressed interest in a product with a particular capability, the marketer may email the consumer when such a product becomes available. As another example, social networking activities of the consumer may be linked across different social networking services if the identity of the consumer is known on the different social networking services. As a further example, campaign/brand information extracted from a conversation could assist a marketer in more accurately determining the return on investment on conversations and analytics around it. Note that these are only some examples of how a social profile generated in accordance with some embodiments may be employed. Additionally, because the user information is available to the marketer, a moderator for the marketer does not need to request the information repeatedly from the consumer in subsequent conversations. This reduces wasted time for the consumer and moderator and also reduces the social posts exchanged between them (which also reduces network bandwidth consumption).

Given the sensitive nature of user information and to ensure user privacy is protected, user information may not be collected and stored in a user profile without the consumer's knowledge and consent. For instance, when the consumer engages in a moderated social conversation with a moderator, a message may be provided to the consumer indicating that user information will be collected from the moderated social conversation. Additionally, the consumer may be given the option to not have any user information collected. If the option is selected by the consumer, the user information will not be collected and stored in a social profile.

Further embodiments of the present invention are directed to more effectively targeting consumers with messages regarding newer versions of a product. In accordance with embodiments, the consumers to target are automatically identified based on their social posts, and the messages to send to the consumers are automatically generated and sent to the consumers as social replies to their social posts. In particular, consumers are targeted by identifying social posts relevant to the product that have a positive user sentiment associated with a product. This reflects that such consumers are more likely to purchase the newer version of the product or otherwise respond positively to a social reply from the marketer. Alternatively, a consumer who submitted a social post that is negative regarding the product may not respond or may respond negatively to such a social reply by posting additional negative social posts on the social networking service. As such, embodiments more effectively target consumers, reducing the number of messages sent by marketers (which also reduces network bandwidth consumption).

To target consumers with automated social replies marketing a newer version of a product, social posts relevant to the product are identified. This may include social posts in which the user discusses a previous version of the product or the newer version of the product. This may also include social posts on social webpages dedicated to the product on social networking services. The identified social posts are analyzed to determine the user sentiment associated with the product. If the user sentiment for a social post meets a sentiment threshold indicating the consumer is satisfied with the product, a social reply is generated and sent as a reply to the social post via the social networking service on which the social post was submitted.

In some embodiments, the content of a social reply may be tailored based on the social post to which it is replying in order to highlight appropriate new or improved features of the newer version of the product. In particular, after a social post is identified as having a user sentiment associated with the product that satisfies a sentiment threshold, the social post is analyzed to determine if the consumer discussed any product features that correspond with new or improved features of the newer version of the product. If so, the social reply is generated such that it emphasizes new or improved features corresponding with the product features discussed in the social post. In instances in which several of such features are identified, the new or improved features may be emphasized in the social reply based on a frequency with which each feature was discussed in the social post and/or a user sentiment associated with each feature. In this way, the social reply is customized to emphasize certain new or improved features of the newer version of the product that are most important to the consumer.

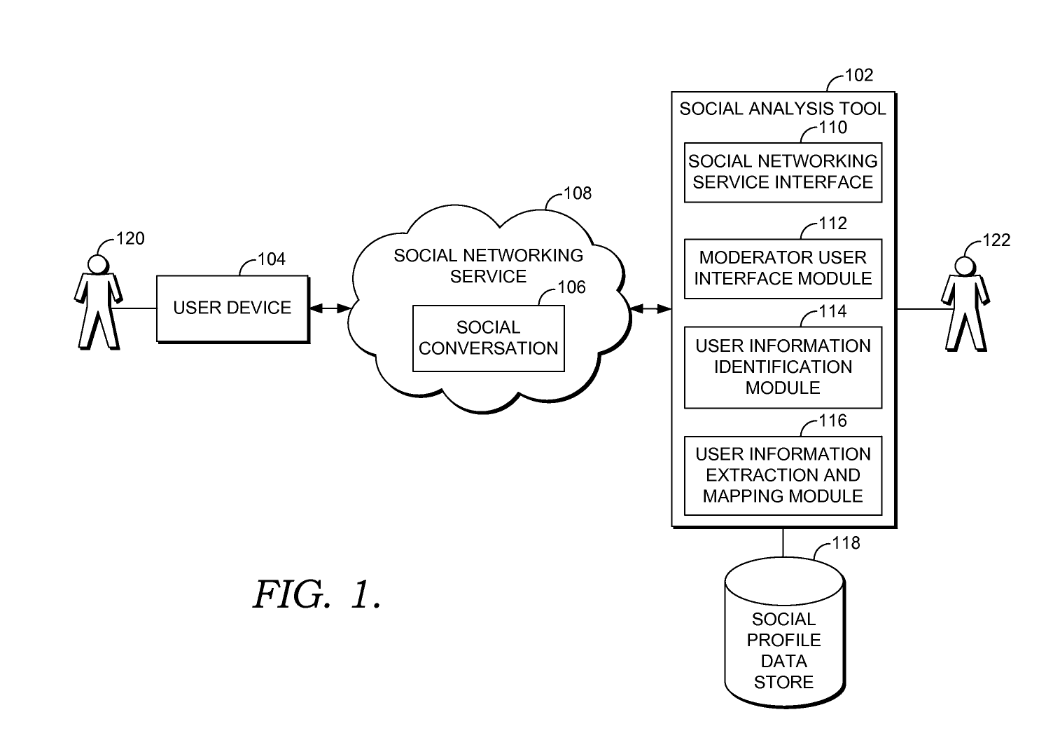

Turning now to FIG. 1, a block diagram is provided illustrating an exemplary system 100 in which some embodiments of the present invention may be employed. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

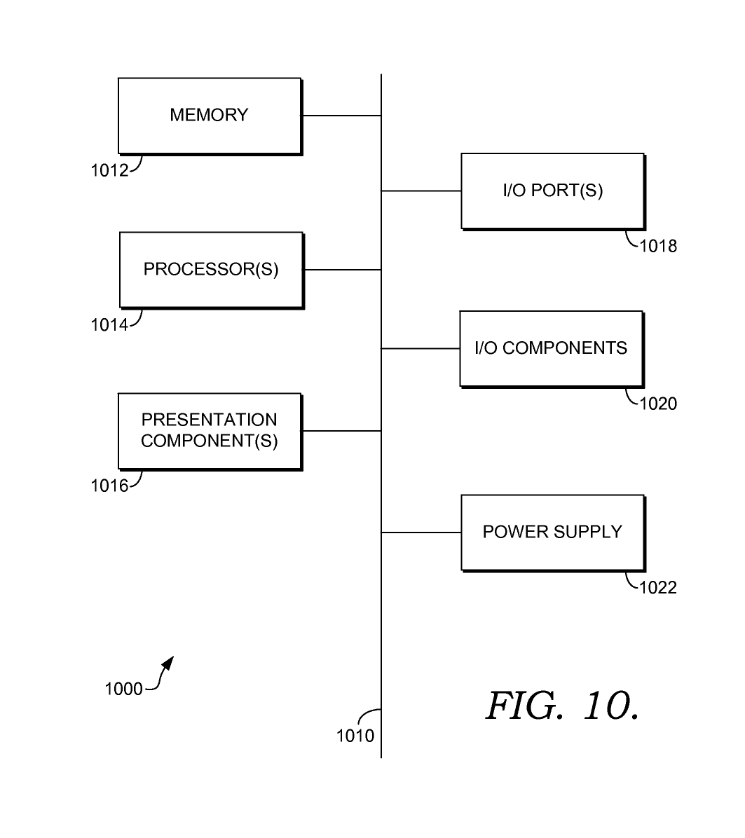

The system in FIG. 1 includes a social analysis tool 102 that is configured to, among other things, identify and extract user information provided by a user 120 during a moderated social conversation 106 on a social networking service 108 and to store that user information in a social profile for the user 120. The social analysis tool 102 may be implemented via any type of computing device, such as computing device 1000 described below with reference to FIG. 10, for example. The social analysis tool 102 may be implemented on a single device or multiple devices cooperating in a distributed environment.

As shown in FIG. 1, the social analysis tool 102 includes a social networking service interface 110 that provides an interface to the social networking service 108. Although only a single social networking service is shown in FIG. 1, it should be understood that the social networking service interface 110 may interface with any number of social networking services and/or the social analysis tool 102 may include any number of social networking service interfaces that interface with different social networking services. The social networking service interface 110 allows a moderator 122 employing the social analysis tool 102 to conduct a moderated social conversation 106 on the social networking service 108 with a user 120 employing a user device 104. Although only a single user/user device is shown in FIG. 1, it should be understood that the moderator 122 may conduct moderated social conversations with any number of users.

The moderated social conversation 106 is an exchange of social posts between the user 120 and the moderator 122 via the social networking service 108. The moderated social conversation 106 may be public such that other users on the social networking service 108 view the social posts, or the conversation may be private such that only the user 120 and moderator 122 view the social posts (e.g., TWITTER direct messages, or FACEBOOK private messages). A moderator user interface module 112 provides a user interface that allows the moderator 122 to engage in the moderated social conversation 106 by displaying social posts from users, such as the user 120, and allowing the moderator 122 to enter social posts to users.

The social analysis tool 102 also includes a user information identification module 114 that operates to analyze the text of user posts from the moderated social conversation 106 to identify user information provided by the user. The user information identification module 114 is configured to identify several different types of user information, such as, for instance, the user's email address, phone, fax, physical address, other social networking service accounts (e.g., TWITTER ID, FACEBOOK account), employment, salary, interests, hobbies, owned products, desired products, product features, skills, credit cards, and social security number or other identifying information. The user information identification module 114 may employ a number of different techniques to identify the user information in the user posts. One technique is to detect certain known patterns in text that match certain types of user information. The following provide some examples of such known patterns: (1) an “@” and “.” in a word is indicative of an email address; (2) a word with 10 numbers is indicative of a phone number; (3) a word with 16 numbers is indicative of a credit card. Using those known patterns, the user information identification module 114 parses the text of the user posts and identifies any words with patterns that match the known patterns. If so, those words are identified as user information. Another technique is to use a set of keywords for certain types of user information, such as for products, brands, campaigns, product features, interests, hobbies, etc. Using those keywords, the user information module 114 parses the text of the user posts and determines if any words match any keywords. If so, those words are identified as user information.

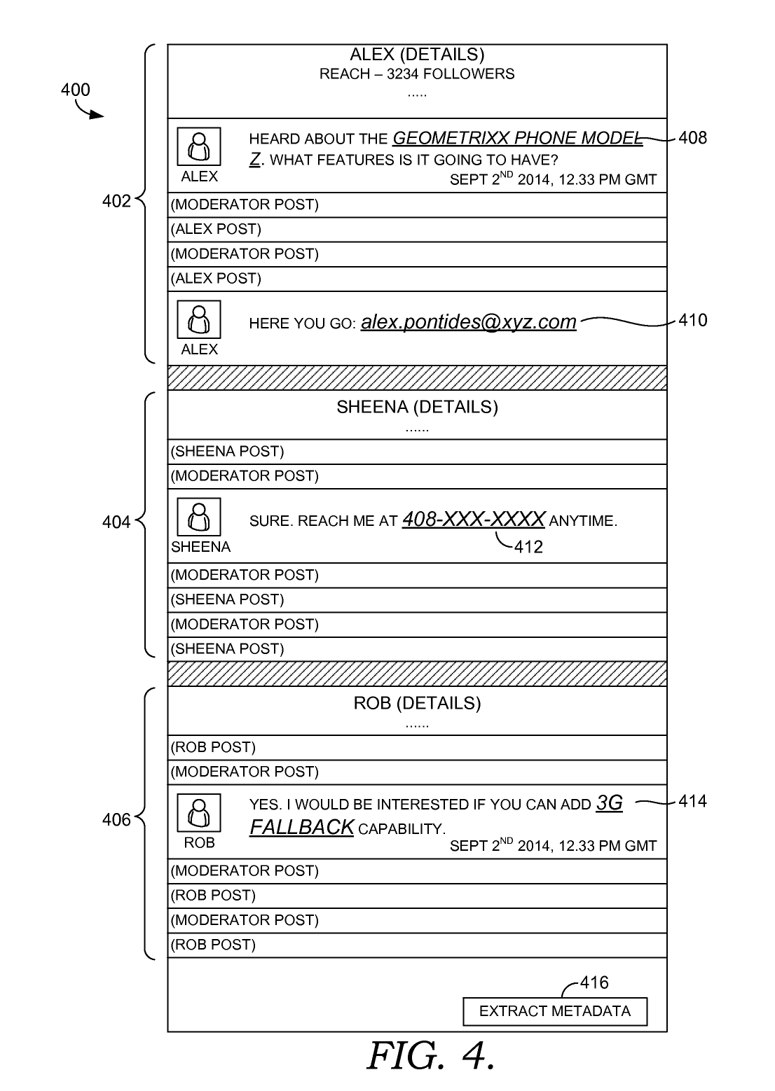

The text of user information in user posts from the moderated social conversation 106 may be displayed differently by the moderator user interface module 112, to bring the moderator's attention to the user information. By way of example to illustrate, FIG. 4 illustrates a moderator user interface 400 provided, for instance, by the moderator user interface module 112. The user interface 400 shows that the moderator has engaged in three separate moderated social conversations: a first moderated social conversation 402 with “Alex”; a second moderated social conversation 404 with “Sheena”; and a third moderated social conversation 406 with “Rob.” Each of the moderated social conversations 402, 404, 406 includes social posts by the moderator and each of the users (note that the text of a number of the social posts is not displayed for clarity purposes). As shown in FIG. 4, a number of pieces of user information have been identified in the user posts and the text of the user information is shown as italicized and underlined, including a product 408, email address 410, phone number 412, and product feature 414.

The social analysis tool 102 further includes a user information extraction and mapping module 116. The user information extraction and mapping module 116 extracts identified user information from social posts from the moderated social conversation 106 and maps the user information to particular data fields for storage in a social profile for the user 120 in a social profile data store 118, which may store a social profile for any number of users. The user information extraction and mapping module 116 may map the extracted user information to data fields based on how the user information was identified by the user information identification module 114. In particular, user information identified based on a known pattern or keyword associated with a particular type of data is mapped to a data filed for that type of data. For instance, if user information is identified as corresponding with a known pattern for an email address (e.g., includes an “@” and “.”), that user information is mapped to an email address data field in the social profile for the user 120. As another example, if user information is identified as corresponding with a keyword for a product, that user information is mapped to a product data field in the social profile for the user 120.

In some embodiments, the user information extraction and mapping module 116 automatically extracts, maps, and stores user information. In other embodiments, the moderator may be involved in mapping and/or storing user information. For instance, the moderator user interface module 112 may present extracted user information and proposed mappings for each piece of user information. The moderator 122 may review the presented information and choose which pieces of user information to store. The moderator 122 may also modify proposed mappings. The moderator may further modify the extracted user information. By way of example to illustrate, the user interface 400 of FIG. 4 includes a button 416. If selected, user information is extracted and mapped to data fields. The extracted user information and proposed data field mappings are presented to the moderator, who may select which pieces of user information to store, modify mappings, and/or modify extracted user information.

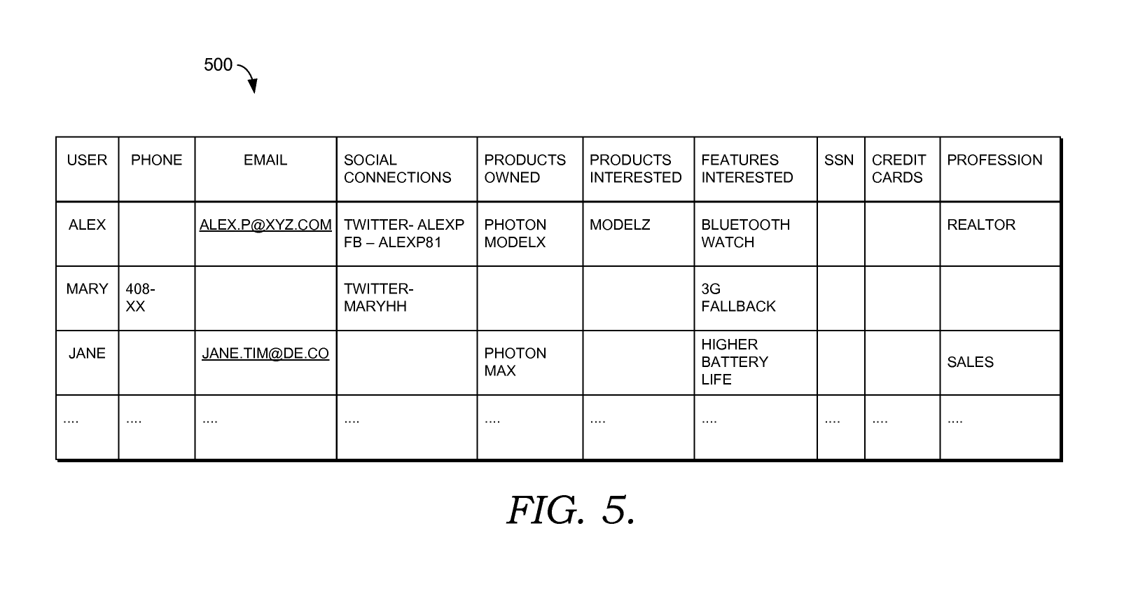

User information may be stored in a social profile for a user using any of a number of different data structures in accordance with various embodiments of the present invention. By way of example only and not limitation, FIG. 5 illustrates a data structure 500 in which each row in the data structure corresponds with a particular user and therefore comprises the social profile for each user. The social profile for each user may be updated from multiple moderated social conversations that occur at different points in time. Each time the user participates in a moderated social conversation with a particular marketer, any new user information identified is added to the social profile for the user. If a data field already contains user information, the new user information may either be added in addition to the existing user information or the new information may be stored and the existing information removed.

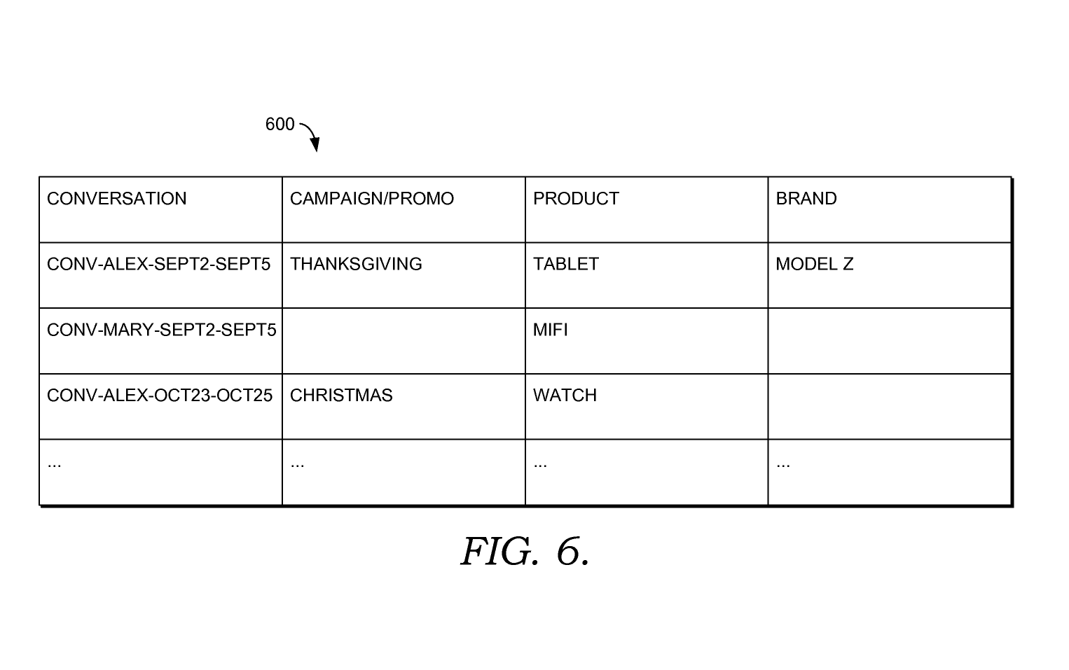

FIG. 6 illustrates another data structure 600 that is used in some embodiments. The data structure 600 organizes user information based on moderated social conversation. In such embodiments, the social profile for a particular user would be a collection of the conversations for that particular user.

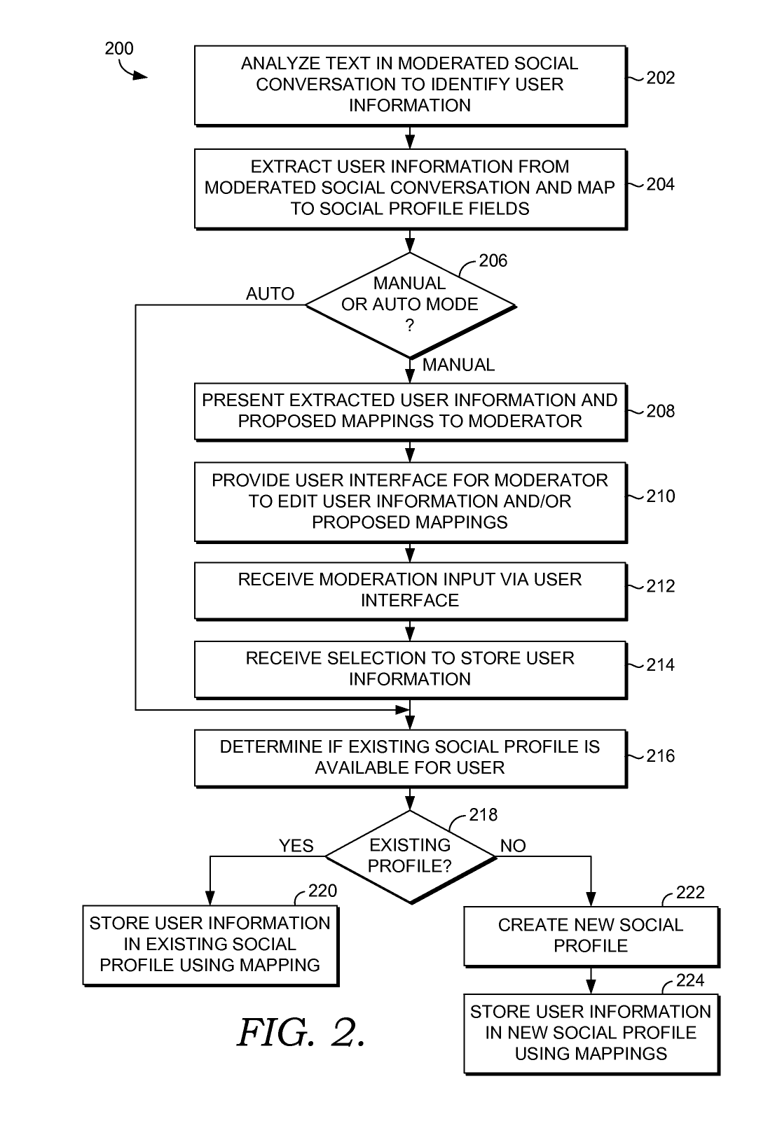

With reference now to FIG. 2, a flow diagram is provided that illustrates a method 200 for identifying user information from a moderated social conversation and populating a social profile for a user with the user information. Each block of the method 200 and other methods described herein comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few. For example, the method 200 may be provided as part of a social analysis tool, such as the social analysis tool 102 of FIG. 1.

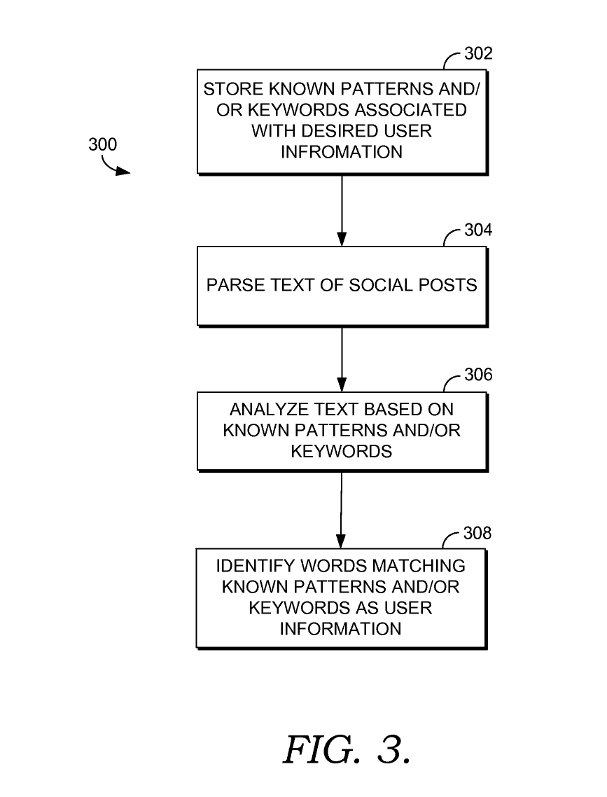

As shown at block 202, text in social posts from a moderated social conversation is analyzed to identify user information. As noted above, a number of techniques may be employed to identify the user information. FIG. 3 illustrates one method 300 for identifying user information. As shown at bock 302, known patterns for user information and/or keywords associated with user information are established and stored in data storage accessible to social analysis tool performing the analysis. The text of social posts from the moderated social conversation is parsed, as shown at block 304. The parsed text is analyzed based on the stored known patterns and/or keywords, as shown at block 308. Words that match any of the known patterns and/or keywords are identified as user information, as shown at block 310.

Returning again to FIG. 2, any identified user information is extracted from the moderated social conversation and mapped to social profile data fields, as shown at block 204. Each piece of user information may be mapped to a corresponding data field based on how each was identified. For instance, user information that was identified based on a known pattern or keyword may be mapped to a data field corresponding with the type of data associated with that known pattern or keyword.

A determination is made at block 206 regarding whether the process is in automatic mode or manual mode. In automatic mode, the process skips to block 216. In manual mode, the process includes presenting extracted user information and proposed mappings to the moderator, as shown at block 208. A user interface is provided to the moderator that allows the moderator to edit user information and/or proposed mapping and to select which pieces of user information to store, as shown 210. Via the user interface, any moderator input modifying the user information and/or proposed mapping and any selections regarding which pieces of user information to store are received as shown at block 212. Additionally, a moderator selection to store the user information with any moderator input is received at block 214.

As shown at block 216, a determination is made if an existing social profile is available for the user. In some instances, a social profile may have been previously created for the user, for instance, from previous moderated social conversation. An existing social profile may be identified based on some identifying information for the user such as a social networking service identifier (e.g., TWITTER ID). If an existing social profile is identified at block 218, the user information is stored in the existing social profile in data fields based on the mapping identified for each piece of user information. If there is existing user information already stored in a data field for which new user information is available, the new user information may be stored with the existing user information or may replace the existing user information.

If an existing social profile is not identified at block 218, a new social profile is generated at block 220. The user information is then stored in the social profile in data fields based on the mapping identified for each piece of user information, as shown at block 224.

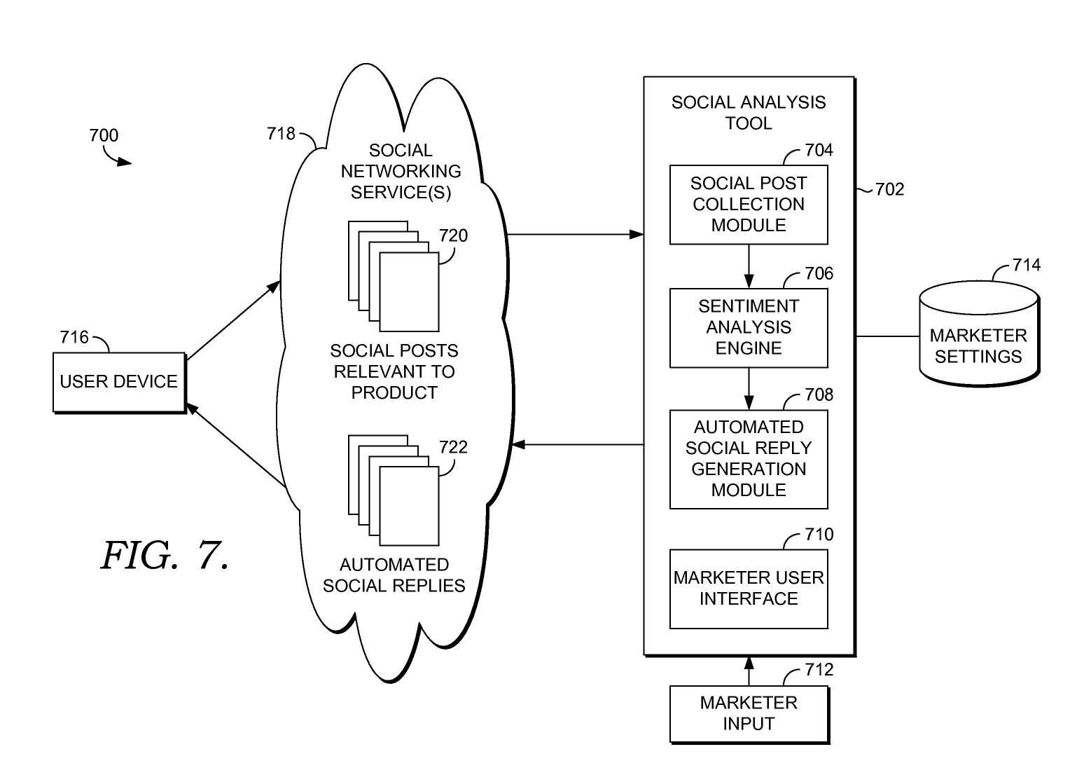

Turning next to FIG. 7, a block diagram is provided illustrating another exemplary system 700 in which some embodiments of the present invention may be employed. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

The system in FIG. 7 includes a social analysis tool 702 that is configured to, among other things, provide automated social replies 722 regarding a newer version of a product based on the user sentiment in social posts 720 relevant to the product submitted by users using user devices 716 via one or more social networking services 718. The newer version of the product may be the latest released version of the product or a latest version of the product that has an upcoming release. The social analysis tool 702 may be implemented via any type of computing device, such as computing device 1000 described below with reference to FIG. 10, for example. The social analysis tool 702 may be implemented on a single device or multiple devices cooperating in a distributed environment.

Initially, a marketer provides a variety of marketer input 712 for use by the social analysis tool 702 in the generation of automated social replies 722. The marketer input 712 is provided, for instance, via a marketer use interface 710 and stored in a marketer settings data store 714. The marketer input 712 provided by the marketer may include identifying information (e.g., a name) of a new version of a product that is being released or planned to be released. The input may also include identifying information (e.g., name) of one or more older versions of the product.

In some instances, the marketer may provide different variations of the new and/or previous product version names to address that users may include different variations in their social posts. In some instances, the social analysis tool 702 employs an algorithm to generate different variations. The algorithm tokenizes the name provided by the marketer to get individual words. If a given token is a numeral, its roman numeral is also considered as a token (e.g., for “2”, the Roman numeral is “II”). Different variations of the product version name are generated by producing different combinations of these tokens with and without spaces. In some instances, the generated variations are presented to the marketer who may then select ones for use.

The marketer may also provide new and/or improved features for the new version of the product, as well as a corresponding description for each new/improved feature. The information is stored as a list of new/improved feature names with their corresponding descriptions. For example, the new/improved features and corresponding descriptions for a new smartphone may include the following: (1) Camera: 13 MP AutoFocus; (2) Battery: 3600 mAH, 10 hours talktime, 6 hours browsing. In this example, the new/improved feature names are “camera” and “battery” and the corresponding descriptions are, respectively, “13 MP AutoFocus” and “3600 mAH, 10 hours talktime, 6 hours browsing.” In some instances, alternative terms are provided for each new/improved feature name. The alternative terms may be provided by the marketer or may be automatically determined by the social analysis tool 702, for instance, by identifying synonyms for the marketer-provided new/improved feature names.

In some instances, the social analysis tool 702 is configured to identify relevant social posts on a default list of social networking services and to provide automated social replies regarding the new version of a product via those social networking services. In other instances, the marketer specifies which social networking services to monitor for relevant social posts and on which to respond with automated social replies regarding the new version of a product. In further instances, the marketer may specify specific social media webpages (i.e., webpages published by social networking services, such as a FACEBOOK page) corresponding to the product in order to monitor and reply to social posts on those social media pages. The marketer may further specify a date range such that automated social replies are provided only for social posts within that date range.

Based on the marketer input 712 provided by the marketer and stored in the marketer settings data store 714, a social post collection module 704 of the social analysis tool 702 collects social posts 720 that are relevant to the product from one or more social networking services 718. The social post collection module 704 is generally configured to assess social posts directly from a social networking service or an entity providing the social analysis tool 702 may access the data from a social networking service and provide the data to the social analysis tool 702. For instance, the social post collection module 704 may be configured to access social posts using APIs provided by a social networking service to expose the data. In other instances, the social post collection module 704 accesses social posts from a third-party social data aggregator (e.g., the GNIP service), which may operate to access data from one or more social networking services, standardize the data, and provide the standardized data. Any and all such variations are contemplated to be within the scope of embodiments of the present invention.

In some instances, the social post collection module 704 operates to collect social posts 720 that are relevant to the product by accessing social posts in which the name of the new version of the product or the name of a previous version of the product is present. In instances in which the marketer specified one or more social networking services, only social posts from those identified social networking services will be collected (i.e., social posts from other social networking services will not be collected). In some instances, the social post collection module 704 additionally or alternatively collects all social posts on specific social media pages corresponding to the product that were identified by the marketer. Further, if the marketer specified a date range, only social posts within that date ranged are collected by the social post collection module 704.

The social analysis tool 702 also includes a sentiment analysis engine 706 that is used to analyze the social posts 720 identified as being relevant to the product. For each social post from the collected social posts 720, the sentiment analysis engine 706 determines a user sentiment associated with the newer or older version of the product mentioned in the social post. This may include determining a sentiment score that reflects the user sentiment associated with the newer or older version of the product. In some instances, the sentiment analysis engine 706 identifies the social post as negative, neutral, or positive based on the sentiment score. For instance, if the sentiment score for a social post is below a first threshold, the user sentiment is considered to be negative; if the sentiment score is above a second threshold, the user sentiment is considered to be positive; and if the sentiment score is between the first and second threshold, the sentiment is considered to be neutral. In some embodiments, a single threshold is employed, and the sentiment is either positive or negative depending on whether the sentiment score is above or below the threshold.

A variety of techniques may be employed to determine the user sentiment associated with a version of a product discussed in a social post. By way of example only, a keyword level sentiment engine may be employed that provides the ability to extract keyword-level sentiment from a piece of text. The ALCHEMYAPI sentiment analysis engine is an example of one such sentiment analysis engine that may be employed to identify the user sentiment associated with a version of a product. Another example is the ADOBE Phoenix and Sentiment Analysis Engine, which can detect, extract, and weight sentence affect and sentiment signal using a general purpose sentiment vocabulary combined with a natural language processing engine. The ADOBE Phoenix and Sentiment Analysis Engine uses as input part of speech and noun/verb tagged sentences and then determines and scores the positive, negative, and/or neutral sentiment associated with various keywords (which may include single words and/or multi-word phrases).

The automated social reply generation module 708 operates to automatically generate automated social replies 722 based on the user sentiment associated with versions of the product in the social posts 720. The automated social replies 722 are then delivered to the users who submitted the social posts 720. Each automated social reply corresponds with a particular social post and is delivered to the user who submitted that social post. An automated social reply is delivered to the user who submitted the social post within the confines of the social networking service on which the social post was submitted, such as, for example, a reply to the social post, a general post within the user's social networking account, or a promoted post within the user's social networking account (e.g., a promoted post delivered via the user's FACEBOOK account, or a promoted tweet delivered via a user's TWITTER account).

The user sentiment associated with the product discussed in a social post dictates whether an automated social reply is generated for that social post. In particular, the automated social reply generation module 708 generates an automated social reply for a given social post only if the user sentiment associated with the product discussed in the social post satisfies a sentiment threshold. The sentiment threshold may be preconfigured in the social analysis tool or may be specified by the marketer via the marketer user interface 710. The sentiment threshold may be, for instance, a particular sentiment score or more simply may be a binary indication of positive or neutral sentiment.

If the user sentiment associated with a version of a product discussed in a social post does not satisfy the sentiment threshold, an automated social reply is not generated for that social post. This reflects that the user who submitted the social post was not satisfied with the product. An automated social reply may not be suitable for such a user. For instance, the user may choose to post a counterproductive/negative reply to the automated social reply. Accordingly, if the marketer chooses to contact such a user, it may be better to contact the user using communication channels that are outside the confines of a social networking service (e.g., an email). As such, in some instances, the social analysis tool is configured to identify social posts that don't satisfy the sentiment threshold to the marketer (e.g., via the marketer user interface 710) to allow the marketer to determine whether to respond to such social posts.

The automated social replies 722 that are provided for social posts satisfying the sentiment threshold may be automatically generated by the automated social reply generation module 708 in a number of different manners in accordance with various embodiments of the present invention. Generally, the automated social replies are messages that promote the newer version of the product.

In some instances, an automated social reply is automatically generated for a social post such that the automated social reply is customized based on the content of that social post. In particular, an automated social reply is generated to highlight new and/or improved features that correspond with features discussed in the social post. This may include situations in which the user is satisfied with a particular feature and that feature has been improved in the newer version of the product. This presents an opportunity to highlight that improved features to the user. For example, suppose a user submits a social post indicating: “I love my Brand X 2 phone. Great camera=fantastic pics!” If the camera has been improved on a newer version of that phone, an automated social reply may be generated that highlights the improved camera. For instance, an automated social reply may be generated that indicates: “If you loved the Brand X 2 phone, you'll love the new Brand X 3 phone even better. Includes an improved 13 MP camera.”

Some situations occur in which the user is not satisfied with a particular feature and that feature has been improved in the newer version of the product. This also presents an opportunity to highlight that improved feature to the user. For instance, suppose a user submits a social post indicating: “I love my Brad X 2 phone, but the battery on standby only lasts 11 hours.” If the battery has been improved on the newer version of the phone, an automated social reply may be generated that highlights the improved battery. For instance, an automated social reply may be generated that indicates: “Get the Brand X 3 phone. It has the best battery life of any phone on the market.”

Other situations occur in which the user is looking for a new feature and that feature has been added in the newer version of the product. This presents an opportunity to highlight the added feature to the user. For instance, suppose a user submits a social post indicating: “I love my Brand X 2 phone. Just wished it had a front facing camera.” If the newer version of the phone includes a front facing camera, that addition may be highlighted in an automated social reply. For instance, an automated social reply may be generated that indicates: “Get the Brand X 3 phone. Now with a 5 MP front facing camera.”

The automated social reply generation module 708 uses the new/improved features specified by the marketer input 712 to identify features discussed in the social posts and determine which new/improved features to highlight when generating the automated social replies. In particular, the text of a social post is analyzed to identify feature terms in the text that correspond with the feature names included in the list of new/improved feature names provided in the marketer input 712. For example, suppose the list of new/improved feature names for a newer version of a phone include: “camera,” “battery,” “display,” and “color.” A social post would be analyzed to determine if the social post contains any feature terms corresponding with the feature names in the list of new/improved features. If so, an automated social post is generated that is customized for that social post to focus on new/improved features that correspond with features mentioned in the social post. As noted above, one or more alternative terms may be available for each new/improved product name. This addresses that different users may use different terms to refer to the same feature.

In some instances, the frequency of each feature term mentioned in a social post is also determined and used when generating the social post. For instance, a natural language processing term frequency tagger may be employed that finds the frequency of each feature term appearing in the social post. This tagger finds any feature terms mentioned in the social post that correspond with the feature names in the list of new/improved features and determines the frequency of each feature term found (e.g., “camera” is mentioned three times and “battery” is mentioned one time).

Identifying feature terms in a social post and determining the frequency of each may include the following process. First, the social post is tokenized. Tokenized text from the social post is then converted to lower case. Stemming is performed to find the stems of words. Lemmatization is also performed to group different forms of the same word to identify them as the same word. Part of speech tagging is performed by classifying words in their parts of speech and labeling them accordingly. This identifies each word as a noun, proper noun, verb, adjective, pronoun, article, etc. Since the new/improved feature names are nouns and proper nouns, the words identified as nouns and proper nouns are extracted and compared to the list of new/improved feature names.

The frequency of feature terms found in a social post may be used to generate the automated social reply to that social post. By way of example only and not limitation, the feature term frequencies may be used to select the new/improved features to include in the social reply. For instance, the automated social reply may have a size limitation such that it can't include all new/improved features corresponding with feature terms found in the social post. In such instances, new/improved features corresponding with feature terms having higher term frequencies in the social post may be selected for inclusion since these features are likely ones that are more important to the user based on the number of mentions in the social post. As an alternative to not including new/improved features, if the automated social reply has a limited size, the amount of text included for each new/improved feature may be varied (e.g., the higher number of new/improved features included, the less text allowed for each new/improved feature). The amount of text allowed for each new/improved feature may also be varied based on feature term frequencies such that new/improved features corresponding with feature terms having high frequencies in the social post may be allotted more text space. The feature term frequencies may also be used to prioritize the new/improved features such that the new/improved features are listed in order from highest corresponding feature term frequency to lowest corresponding feature term frequency. Any and all such combinations and variations thereof are contemplated to be within the scope of embodiments of the present invention.

The user sentiment associated with feature terms in a social post may be determined and used when generating the automated social reply to that social post. The user sentiment may be used in conjunction with feature term frequencies when generating the automated social reply or the user sentiment may be used alone (i.e., feature term frequency would not be considered). The user sentiment associated with feature terms in a social post is determined using the sentiment analysis engine 706, employing similar sentiment analysis techniques discussed above to determine the user sentiment associated with a product in a social post.

The user sentiment may be used to generate an automated social reply to a social post in a number of different manners in accordance with various embodiments of the present invention. As with term frequency, the user sentiment may be used to, among other things, select which new/improved features to include in the automated social reply, the amount of text allotted to each included new/improved feature, and/or the order in which the new/improved features are provided in the automated social reply. In some instances, new/improved features corresponding with feature terms with negative user sentiment may be considered as higher priority than features with positive user sentiment. This allows the automated social reply to better emphasize new/improved features corresponding with features the user was negative about in the social post. If a sentiment score or other range of sentiment is provided for each feature term, the corresponding new/improved features may be ranked from the most negative user sentiment to the most positive user sentiment. Such a ranking may then be used when generating the automated social reply, for instance, in order to select new/improved features for inclusion, determining how much space to allot to each new/improved feature, and/or order the new/improved features in the automated social reply.

In some instances, an automated social reply simply includes a generic message regarding the newer version of the product. This may occur in situations, for instance, in which the social post does not mention any features of the version of the product discussed in the social post. For example, suppose a user submitted a social post indicating: “I love my Brand X 2 phone!!!” In this example, the user has not mentioned any features regarding the phone. If the marketer is marketing the newer version of the phone (e.g., the “Brand X 3” phone), the automated social reply generated for the social post includes a generic message regarding the newer version of the phone that is not customized based on the content of the social post. The message may simply indicate that the newer version of the phone is being released or may highlight new and/or improved features for the newer version of the phone.

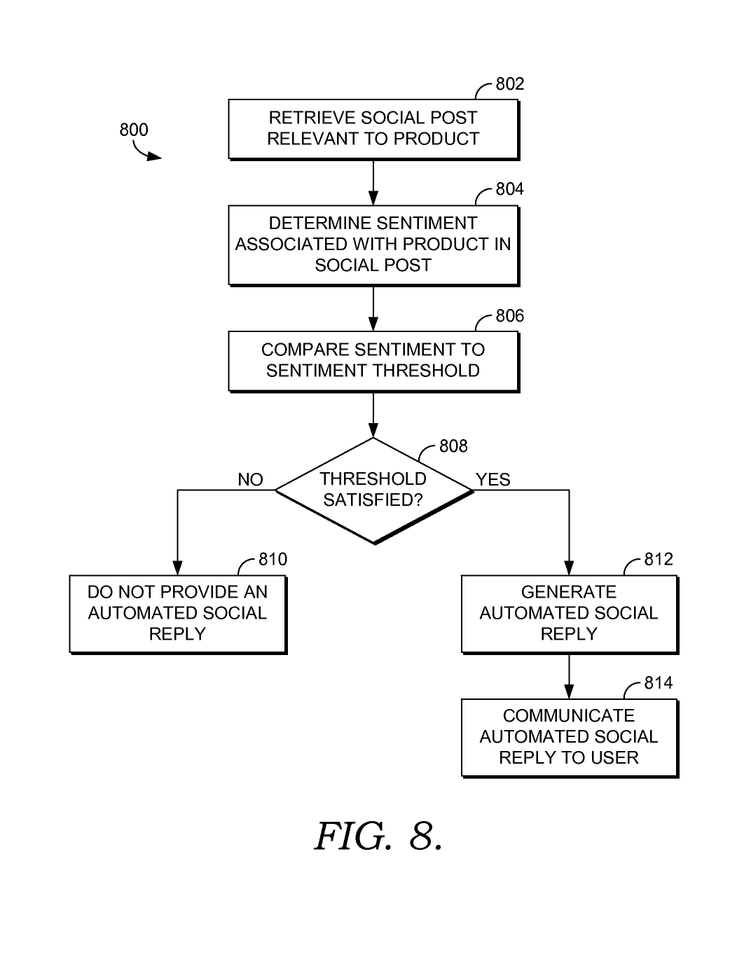

Referring next to FIG. 8, a flow diagram is provided that illustrates a method 800 for providing an automated social reply to a social post based on a user sentiment associated with a product discussed in the social post. The method 800 may be performed, for instance, by the social analysis tool 702 of FIG. 7. As shown at block 802, a social post relevant to a particular product is retrieved. This social post may be determined as relevant to the product based on the user discussing the product (older version or newer version). The social post may also be determined based on being posted on a social webpage associated with the product.

A user sentiment associated with the product in the social post is identified, as shown at block 804. The user sentiment is compared to a sentiment threshold, as shown at block 806. If it is determined at block 808 that the user sentiment does not satisfy the sentiment threshold, an automated social reply is not provided for the social post, as shown at block 810.

Alternatively, if it is determined at block 808 that the user sentiment does satisfy the sentiment threshold, an automated social reply is automatically generated, as shown at block 812. The automated social reply is communicated to the user who submitted the social post using the social networking service on which the social post was submitted, as shown at block 814.

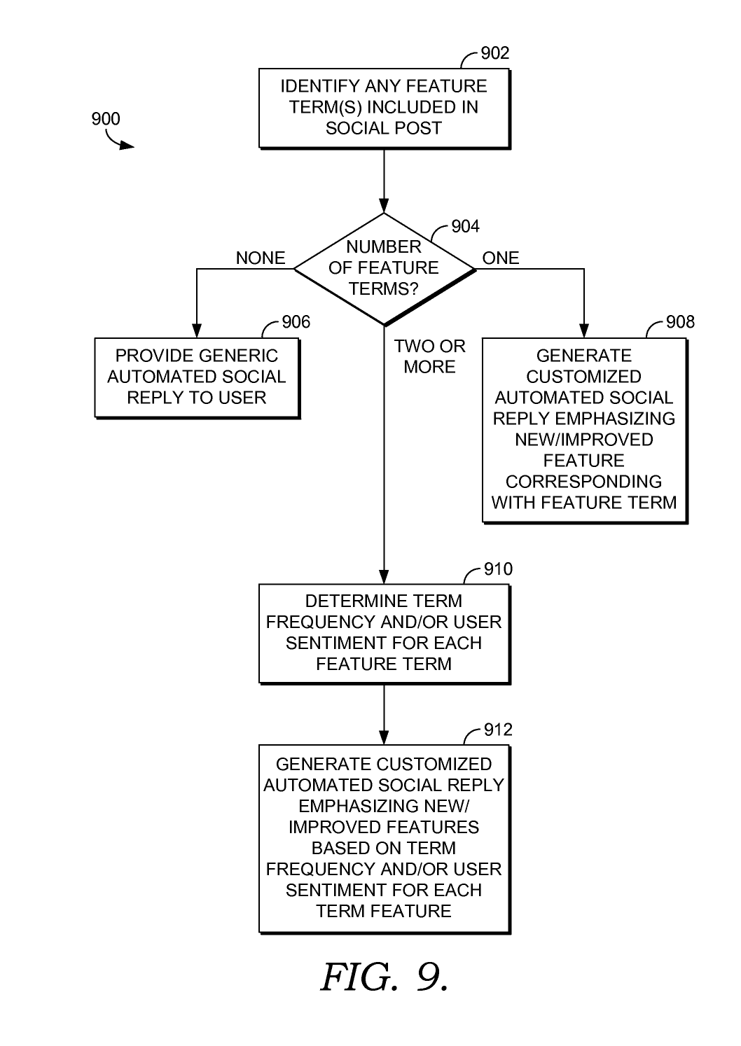

FIG. 9 illustrates one method 900 for automatically generating an automated social reply for a social post. As shown at block 902, the text of the social post is analyzed to determine if it contains any feature terms that match the feature names of new or improved features for the newer version of the product. If it is determined at block 904 that the social post does not contain any such feature terms, a generic automated social reply is provided to the user, as shown at block 906. If it is determined at block 904 that the social post contains a single feature term that matches a feature name of a new or improved feature, a customized automated social reply is generated to emphasize that new or improved feature.

If it is determined at block 904 that two or more feature terms match different feature names of new or improved features, the frequency with which each feature term appears in the social post is determined and/or the user sentiment associated with each feature term is determined, as shown at block 910. An automated social reply is generated to emphasize new or improved features of the newer version of the product based on the feature term frequencies and/or user sentiment for each feature term, as shown at block 912. In some embodiments, this includes generating a score (e.g., a ranking) for each new or improved feature based on the frequency and/or user sentiment associated with corresponding feature terms from the social post. The new or improved features are then emphasized in the automated social reply based on the score, for instance, to control which new or improved features are included in the automated social reply, the order in which the new or improved features are included, the amount of text or other formatting applied to each new or improved feature.

Having described embodiments of the present invention, an exemplary operating environment in which embodiments of the present invention may be implemented is described below in order to provide a general context for various aspects of the present invention. Referring initially to FIG. 10 in particular, an exemplary operating environment for implementing embodiments of the present invention is shown and designated generally as computing device 1000. Computing device 1000 is but one example of a suitable computing environment and is not intended to suggest any limitation as to the scope of use or functionality of the invention. Neither should the computing device 1000 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 10, computing device 1000 includes a bus 1010 that directly or indirectly couples the following devices: memory 1012, one or more processors 1014, one or more presentation components 1016, input/output (I/O) ports 1018, input/output components 1020, and an illustrative power supply 1022. Bus 1010 represents what may be one or more busses (such as an address bus, data bus, or combination thereof). Although the various blocks of FIG. 10 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 10 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 10 and reference to “computing device.”

Computing device 1000 typically includes a variety of computer-readable media. Computer-readable media can be any available media that can be accessed by computing device 1000 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 1000. Computer storage media does not comprise signals per se. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 1012 includes computer-storage media in the form of volatile and/or nonvolatile memory. The memory may be removable, non-removable, or a combination thereof. Exemplary hardware devices include solid-state memory, hard drives, optical-disc drives, etc. Computing device 1000 includes one or more processors that read data from various entities such as memory 1012 or I/O components 1020. Presentation component(s) 1016 present data indications to a user or other device. Exemplary presentation components include a display device, speaker, printing component, vibrating component, etc.

I/O ports 1018 allow computing device 1000 to be logically coupled to other devices including I/O components 1020, some of which may be built in. Illustrative components include a microphone, joystick, game pad, satellite dish, scanner, printer, wireless device, etc. The I/O components 1020 may provide a natural user interface (NUI) that processes air gestures, voice, or other physiological inputs generated by a user. In some instance, inputs may be transmitted to an appropriate network element for further processing. A NUI may implement any combination of speech recognition, touch and stylus recognition, facial recognition, biometric recognition, gesture recognition both on screen and adjacent to the screen, air gestures, head and eye tracking, and touch recognition associated with displays on the computing device 1000. The computing device 1000 may be equipped with depth cameras, such as, stereoscopic camera systems, infrared camera systems, RGB camera systems, and combinations of these for gesture detection and recognition. Additionally, the computing device 1000 may be equipped with accelerometers or gyroscopes that enable detection of motion. The output of the accelerometers or gyroscopes may be provided to the display of the computing device 1000 to render immersive augmented reality or virtual reality.

As can be understood, embodiments of the present invention improve marketers' social networking communications with consumers. Some embodiments facilitate the automatic collection of user information that may be used by marketers in subsequent social conversations. Further embodiments effectively target users who submit social posts in which the users are satisfied with the product by automatically generating and responding to the social posts with social replies regarding a newer version of the product. The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. One or more computer storage media storing computer-useable instructions that, when used by one or more computing devices, cause the one or more computing devices to perform operations comprising:
accessing social posts from a moderated social conversation between a moderator and user on a computerized social networking service;
analyzing text of the social posts to identify user information provided by the user;
extracting the user information and mapping the extracted user information to a data field of a social profile; and
storing the extracted user information in the data field of the social profile on a computer storage device.

2. The one or more computer storage media of claim 1, wherein analyzing text of the social posts to identify the user information comprises:
parsing the text of the social posts;
analyzing the parsed text based on a set of known patterns; and
identifying one or more words matching a known pattern from the set of known patterns as the user information.

3. The one or more computer storage media of claim 1, wherein analyzing text of the social posts to identify the user information comprises:
parsing the text of the social posts;
analyzing the parsed text based on a set of keywords; and
identifying one or more words matching a keyword from the set of keywords as the user information.

4. The one or more computer storage media of claim 1, wherein the user information is mapped to the data field of the social profile by:
identifying the user information as corresponding with a particular type of user information; and
identifying the data field as corresponding with the particular type of user information.

5. The one or more computer storage media of claim 4, wherein the user information is determined as corresponding with the particular type of user information based on a known pattern or keyword used to identify the user information, the known pattern or keyword being associated with the particular type of user information.

6. The one or more computer storage media of claim 1, wherein the operations further comprise:
presenting the user information and the data field to the moderator via a user interface; and
receiving one or more modifications to the user information or the data field via the user interface.

7. A computerized method for automating generating and providing an automated social reply in response to a social post from a user posted on a computerized social networking service, the computerized method comprising:
receiving, via a first computing process, the social post over a communication network based on the social post being relevant to a product;
employing, via a second computing process, a sentiment analysis engine to determine a user sentiment associated with the product in the social post;
comparing, via a third computing process, the user sentiment to a sentiment threshold;
determining, via a fourth computing process, that the user sentiment satisfies the sentiment threshold;
generating, via a fifth computing process, the automated social reply promoting a newer version of the product based on determining that the user sentiment satisfies the sentiment threshold; and
providing, via a sixth computing process, the automated social reply to the user by communicating the automated social reply over a communication network to the computerized social networking service;
wherein the first, second, third, fourth, fifth, and sixth computing processes are performed by one or more computing devices.

8. The computerized method of claim 7, wherein the social post is relevant to the product based the text of the social post containing a name of a previous version of the product.

9. The computerized method of claim 7, wherein the social post is relevant to the product based on the social post being posted on a webpage of the social networking service dedicated to the product.

10. The computerized method of claim 7, wherein a marketer specified a date range and the social post is received based on the social post being posted within the date range.

11. The computerized method of claim 7, wherein the user sentiment comprises a sentiment score and the sentiment threshold is a threshold score, and wherein the user sentiment satisfies the sentiment threshold based on the sentiment score being above the threshold score.

12. The computerized method of claim 7, wherein the automated social reply is generated by:
analyzing text of the social post to determine if the text includes any feature terms matching any of a plurality of feature names of new or improved features of the newer version of the product;
determining that the text of the social post does not contain any feature terms matching any of the plurality of feature names; and
providing a generic message regarding the newer version of the product for the automated social reply.

13. The computerized method of claim 7, wherein the automated social reply is generated by:
analyzing text of the social post to determine if the text includes any feature terms matching any of a plurality of feature names of new or improved features of the newer version of the product; determining that the text of the social post contains only one feature term matching a first feature name corresponding with a first new or improved feature of the newer version of the product; and
generating the automated social reply by including content that emphasizes the first new or improved feature of the newer version of the product.

14. The computerized method of claim 7, wherein the automated social reply is generated by:
analyzing text of the social post to determine if the text includes any feature terms matching any of a plurality of feature names of new or improved features of the newer version of the product;
identifying each of a plurality of feature terms in the text of the social post as matching a different feature name from the plurality of feature names;
determining a frequency with which each of the plurality of feature terms appears in the text of the social post; and
generating the automated social reply based on the frequency with which each of the plurality of feature terms appears in the text of the social post.

15. The computerized method of claim 14, wherein generating the automated social reply based on the frequency with which each of the plurality of feature terms appears in the text of the social post comprises:
determining a score for each new or improved feature of a subset of the new or improved features corresponding with the feature terms appearing in the text of the social post based on the frequency with which each of the plurality of feature terms appears in the text of the social post; and
generating the automated social reply to emphasize each new or improved feature of the subset based on the score for each new or improved feature of the subset.

16. The computerized method of claim 7, wherein the automated social reply is generated by:
analyzing text of the social post to determine if the text includes any feature terms matching any of a plurality of feature names of new or improved features of the newer version of the product;
identifying each of a plurality of feature terms in the text of the social post as matching a different feature name from the plurality of feature names;
determining a user sentiment associated with each of the plurality of feature terms; and
generating the automated social reply based on the user sentiment associated with each of the plurality of feature terms.

17. The computerized method of claim 16, wherein generating the automated social reply based on the user sentiment associated with each of the plurality of feature terms comprises:
determining a score for each new or improved feature of a subset of the new or improved features corresponding with the feature terms appearing in the text of the social post based on the user sentiment associated with each of the plurality of feature terms; and
generating the automated social reply to emphasize each new or improved feature of the subset based on the score for each new or improved feature of the subset.

18. A computerized system comprising:
one or more processors; and
one or more computer storage media storing computer-useable instructions that, when used by the one or more processors, cause the one or more processors to:
access, over a communication network, a social post posted by a user on a computerized social networking service, the social post being accessed based on the social post having relevance to a product;
analyze text of the social post to determine a user sentiment associated with the product;
determine that the user sentiment is above a sentiment threshold;
in response to determining the user sentiment is above the sentiment threshold:
analyze the text of the social post to identify a plurality of feature terms that each match a different feature name from a plurality of new or improved features of a newer version of the product;
determine a frequency with which each feature term appears in the social post;
determine a user sentiment associated with each feature term;
generate a social reply emphasizing selected new or improved features of the newer version of the product based on the frequency with which each feature term appears in the social post and the user sentiment associated with each feature term; and
provide the social reply for presentation to the user by communicating the social reply over a communication network to the computerized social networking service.

19. The system of claim 18, wherein the social post is determined to be relevant to the product based on the text of the social post including the name of an older version of the product or the newer version of the product.

20. The system of claim 18, wherein the social reply is generated to emphasize the selected new or improved features of the newer version of the product by:
determining a score for each of the selected new or improved features based on the frequency with which each feature term appears in the social post and the user sentiment associated with each feature term; and emphasizing the selected new or improved features based on the scores.
